(19) United States
(12) Patent Application Publication
(10) Pub. No.: US 2025/0145842 A1
(43) Pub. Date: May 8, 2025

(54) DECORATIVE PANEL, DECORATIVE COVERING, METHOD AND SYSTEM FOR PRODUCING SUCH A PANEL

(71) Applicant: NORTHANN BUILDING SOLUTIONS LLC, Sacramento, CA (US)

(72) Inventor: Lin LI, Sacramento, CA (US)

(73) Assignee: NORTHANN BUILDING SOLUTIONS LLC, Sacramento, CA (US)

(21) Appl. No.: 18/833,385

(22) PCT Filed: Jan. 25, 2023
(86) PCT No.: PCT/EP2023/051759

§ 371 Date: Jul. 25, 2024

(30) Foreign Application Priority Data
Jan. 25, 2022 (NL) 2030694

(51) Int. Cl. C09D 5/28; E04F 13/08; E04F 15/02; E04F 15/10

(52) U.S. Cl. CPC C09D 5/28; E04F 13/0866; E04F 13/0871; E04F 15/107; E04F 13/0894; E04F 15/02038; E04F 2201/0146; E04F 2201/0153; E04F 2201/042; E04F 2201/043

(57) ABSTRACT

The invention relates to a decorative panel, in particular a floor panel, ceiling panel, wall panel, or alternative surface covering panel. The invention also relates to a decorative covering, in particular a floor covering, ceiling covering, wall covering, or alternative surface covering, comprising a plurality of decorative panels according to the invention. The invention further relates to a method for producing a decorative panel, in particular a decorative panel according to the invention. The invention furthermore relates to a system for producing a decorative panel, in particular a decorative panel according to the invention and/or wherein is use made of the method according to the invention.

### TECHNICAL FIELD

The invention relates to a decorative panel, in particular a floor panel, ceiling panel, wall panel, or alternative surface covering panel. The invention also relates to a decorative covering, in particular a floor covering, ceiling covering, wall covering, or alternative surface covering, comprising a plurality of decorative panels according to the invention. The invention further relates to a method for producing a decorative panel, in particular a decorative panel according to the invention. The invention furthermore relates to a system for producing a decorative panel, in particular a decorative panel according to the invention and/or wherein is use made of the method according to the invention.

### BACKGROUND

In the field of decorative floor coverings, decorative panels are known having a MDF (Medium Density Board) or HOF (High Density Board) based core layer on top of which a decorative substrate is attached to provide the panels a desired appearance. A major disadvantage of these known panels is the hygroscopic nature of the core layer, which affects the lifetime and durability of such panels. For this reason, the traditional MDF/HDF based panels are more and more replaced by polyvinyl chloride (PVC) based panels, also provided with a decorative top structure on top. These PVC based panels have the advantage over of being relatively waterproof compared to MDF/HDF based panels. The PVC based panels are typically enriched with chalk (calcium carbonate), acting as inert filler, wherein the applied amount of chalk has been increased in the course of time, in particular to reduce the cost price of the panels. These panels are also referred to as stone-plastic composite (SPC) panels. Typically, these panels comprise a decorative layer covered by a wear layer to protect said decorative layer and to lengthen the useful life of the floor panel as such. Such wear layers are often composed of transparent polyvinylchloride (PVC) or transparent polyurethane (PU). A top coating may be applied on top of said wear layer to improve the scratch resistance of the floor panel. Although the above decorative floor coverings have advantages, a remaining drawback of various floor panels is that the floor panels are not configured to withstand high local pressures exerted onto the floor panel during normal use, e.g. walking across said floor panels with high-heel shoes, which easily leads to dents (indentations), holes, or other kind of damages. This inferior indentation and impact resistance may be caused by a relatively thin and/or soft wear layer and/or core layer, which is unable to resist heavy objects or impacts, and which may easily lead to (micro-) damages, and/or plastic deformation (permanent deformation). Another drawback of the production process of known decorative panels is that the manufacturing of the decorative top structure is relatively expensive, time-consuming, and typically not very environmental-friendly. Moreover, the known decorative panels typically release smellable and non-smellable, and often toxic, chemical substances, such as plasticizers (if applied), which is undesired from a safety and comfort point of view.

### SUMMARY

It a first object of the present invention to provide a decorative panel suitable with an improved impact resistance.

It a second object of the present invention to provide a laminated decorative panel comprising an improved decorative top structure with an improved impact resistance.

It a third object of the present invention to provide a laminated decorative panel comprising an improved, polymer based, decorative top structure with an improved impermeability for substances present in the panel.

It a fourth object of the present invention to provide a odor poor, in particular odorless, decorative panel.

It a fourth object of the present invention to provide a laminated decorative panel which can be produced in a cost-efficient and/or time-efficient manner.

At least one of these objects is met by the provision of a decorative panel according to the preamble, wherein the panel comprises a core provided with an upper side and a lower side, a decorative top structure affixed, directly or indirectly, on said upper side of the core, said decorative top structure comprising: at least one decorative print layer forming and/or defining at least one decor image, at least one substantially transparent or translucent, preferably multi-layered, covering structure at least partially covering said print layer, wherein the covering structure is at least partially cured by means of Electron Beam (EB) curing. Preferably, the covering structure is composed of a plurality of layers, and comprises at least one wear layer and a top coating, directly or indirectly, on top of said at least one wear layer, wherein at least one layer of the multi-layered covering structure is an Electron Beam (EB) cured layer. With an EB cured layer is meant a layer which is at least partially cured by means of EB curing.

An electron beam (EB) is a bundle, also referred to as a beam, of moving (and initially accelerated) electrons having a certain amount of energy. The electrons of the beam are gathered together in space and moving in the same direction. By using this EB, initially liquid material can be hardened into at least partially, preferably entirely, solid materials. This process is called EB curing. Electron accelerators used to produce an EB are preferably low-energy electron accelerators. EB accelerators can be made in a number of ways: (i) cathode ray tubes (CRT) that sweep or scan the process area, (ii) electron wide-area curtains and (iii) sealed vacuum tube systems.

The CRT accelerator type comprises a filament or cathode providing a point source of electrons. These electrons become a beam when they are accelerated across a voltage potential and reach very high velocities. With an electron beam that cures coatings and/or inks, the scanned beam leaves the vacuum by passing through an ultra-thin window and strikes the uncured ink or coating to instantly curing it.

The wide-area curtain accelerator type commonly comprises at least one continuous filament formed and cut to length so the filament itself approximates the width of the application area. With this design, the filament is able to emit a shower or wide area curtain of electrons uniformly across a given area. Extending the target width of an accelerator becomes a matter of building longer filaments and the support structures needed to hold them and the accelerator housing. This curtain approach permits building accelerators capable of depositing electrons on webs up to 2 meters wide. Alternatively, a plurality of short filaments may be applied, preferably oriented in the direction of the web, which filaments are, in turn, connected to each other in parallel.

With CRT and most curtain systems, a separate vacuum pump and system is supplied with the accelerator. The vacuum system is a user serviceable design.

Sealed tube systems require no vacuum system, but normally these systems must be returned to the manufacturer periodically for refurbishment.

The total absorption by one or more target layers of the panel to be cured by the EB is called the dose. Dose is often expressed in megarads, wherein is equal to 10 kilograys (10 joules per gram of absorbed energy). The gray is the internationally used unit of dosimetry for EB. The curing of most coatings, inks and adhesives requires dose exposure in the range of 1 to 3 megarads (10 to 30 kilograys) to exhibit full cure.

In contrast to electron beam exposure, ultraviolet exposure is often in the range of 0.1 to 0.5 joules. Because of differences in web speeds and lamp intensity vs. beam currents, it is difficult to establish any exact correlation between the exposure dose under an electron beam and that under a system of ultraviolet lamps.

The EB curing mechanism fundamentally differs from the traditionally used UV curing mechanism. In the UV curing mechanism, at least one photo-initiator absorbs UV light and generates free radicals (or cations) that trigger the polymerization and cross-linking of monomers and oligomers with unsaturated double bonds (or epoxy groups), wherein all new bonds within a layer (intralayer) are generated through the cross-linking polymerization of unsaturated double bonds (or epoxy groups). During EB curing, the EB randomly generates free radicals, including cationic radicals, anionic radicals and monomer and oligomer cleavage radicals, to trigger the polymerization and cross-linking of monomers and oligomers with unsaturated double bonds, wherein the randomly generated free radicals themselves can also cross-link or bond the unsaturated (uncured) layer(s) to produce cross-linking and can even react with the layer(s), which is referred to as grafting, resulting in a wider and more complex range of new bonds, which, inter alia, leads to a cured layer with an increased hardness, and therefore an improved impact resistance, which is in favour of the lifespan of the panel as such. Moreover, due to the wider and more complex range of bonds, typically resulting in a relatively high cross-link density and/or an increased cross-link depth (due to the higher penetration depth), volatile substances, such as odorants, plasticizers, and/or toxic or non-toxic substances, initially present within the panel can be preserved within the panel, as the EB cured layer(s) is/are relatively impermeable for those substance. An additional advantage of EB curing is that expensive photo-initiators are no longer needed in the layer(s) which are to be entirely cured by means of EB curing, which reduces the cost of the layer composition. Moreover, omitting to apply photoinitiators will prevent, during and after production, residual photoinitiators and photolysis products migration and volatilization, causing unpleasant odors. Furthermore, EB curing can be performed in a relative energy-efficient manner, which is (significantly) more energy saving than thermal curing (UV curing). Moreover, EB curing typically results to a matter appearance of the panel compared to traditional UV curing. A matter appearance is caused by a less reflective panel surface, which typically improves the realistic appearance of the panel, in particular in case at least one decor image shows one or more natural materials, such as wood.

Hence, EB curing has significant advantages over traditional UV curing. Unlike UV curing, where photons emitted by an ultraviolet (UV) lamp, such as a mercury or gallium lamp, have only minuscule mass and are easily stopped at the surfaces of materials, electrons have much more mass and can penetrate films. Thick and opaque films can be cured with electron beams. As the EB voltage increases, so does the electron energy—and the depth of cure. Hence, by means of EB curing, the penetration depth can be regulated, dependent on the energy density used, which makes EB curing not only suitable for curing of single layer of the covering structure of the panel according to the invention, but also to simultaneously and/or successively curing a plurality of (initially uncured) layers of the covering structure, up to several millimeters or even several centimeters thick. Moreover, contrary to UV curing, EB curing allows double-sided curing, which makes it e.g. possible to cure at least a part of the covering structure and at least a part of a backing layer applied to a rear side of the core and/or the core itself and/or any other layer of the panel.

Atmospheric oxygen typically reacts very quickly with carbon-centered radicals to give slow-reacting peroxy radicals, which effectively inhibit the EB curing process. Because of this oxygen-inhibition effect, it is preferred for EB curing to use an inert gas to displace oxygen from a reaction chamber (reaction space) of an EB unit (EB curing station) where the curing occurs. This is usually accomplished by purging the reaction chamber with high-purity nitrogen.

The composition of layer material to be cured by means of EB curing can be essentially the same as that of UV curing materials, except that electron beam curing materials do not use-relatively expensive-photoinitiators. This is a great advantages as the layer compositions do not have to be reformulated, and use can still be made of existing application hardware (coating stations and/or printing stations).

The top coating preferably has surface density situated between 6 g/m² and 18 g/m², preferably between 8 g/m² and 16 g/m², more preferably between 10 g/m² and 14 g/m². Preferably, the top coating is a substantially uniform top coating (having a uniform thickness).

Preferably, the top coating is an Electron Beam (EB) cured top coating, as this top coating typically defines the most upper layer of the panel according to the invention. This leads to a relatively hard, scratch-resistant, and odorless top coating, and hence panel as such. To this end, the top coating is preferably free of any photoinitiator to save costs and to prevent odor formation. Preferably, the top coating is chemically bonded, in particular grafted, to at least one adjacent layer of the covering structure, preferably the at least one adjacent wear layer. This interlayer bonding will reinforce the bonding between the layer and will therefore strengthen the panel as such.

Preferably, the, preferably EB cured, top coating is essentially impermeable for substances, such as an odorous and/or plasticizing substance, optionally present in and/or optionally making part of other layers of the decorative panel. Due to the relatively high cross-link density that can be obtained within the top coating and optionally one or more layers situated below the top coating, a relatively dense network of polymeric chains within the top coating (and possibly in between adjacent layers) can be obtained which inhibits molecules, such as odors or plasticizers, to migrate through said network layer.

In a preferred embodiment, the at least one layer of the multi-layered covering structure, preferably the top coating, is cured at an irradiation dose situated between 20 kGy and 50 kGy, preferably between 30 kGy and 40 kGy.

Preferably, wherein the top coating is provided, directly or indirectly, on an upper surface of the wear layer, and in case a plurality of wear layers is applied, on an upper surface of the upper wear layer.

In a preferred embodiment, the core comprises at least one additive to provide the core the property to be positively electrostatically charged. This positive charge will attract the EB during the EB curing process, which typically be in favour of the curing resolution and will impede divergence of the EB beam. Examples of such additives are: animal skin particles, such as leather particles, in particular leather fibers, glass, nylon, wool, and cellulose, in particular paper. It may also be desired to keep the core electrostatically as neutral as possible, also to not disturb other printing process steps. To this end, the core may be provided with cotton particles. Optionally, during EB curing, the core is grounded to discharge electrostatic charges from a surface to be printed and/or cured.

In a preferred embodiment, at least one layer of the printed multi-layered covering structure, in particular the wear layer, is formed by a substantially transparent or translucent three-dimensional embossing structure at least partially covering said decorative print layer. This will provide the covering structure, and hence the panel, with a textured (upper) surface. Preferably, the texture surface makes part of at least one transparent and/or translucent layer, in particular at least one wear layer and/or at least one top coating. Preferably a decorative visual print layer is located underneath said at least one transparent and/or translucent layer. This textured surface (relief surface) typically improves the optical and haptic appearance of the decorative layer. Said textured surface comprises a pattern of recesses (indentations or impressions) and/or projections, wherein said pattern is preferably at least partially realized by means of printing, in particular digital printing (i.e. by means of a digital printing technique). Digital printing is a method of printing from a digital-based image directly to a media. This digital image can be a decorative image, such as the aforementioned decorative visual print, but also an image representing another part of the top structure, such as at least one wear layer and/or at least one top coating. The digital image can either be a 2D or a 3D image. By digitally (3D) printing the top structure, an infinite degree of freedom of design of the top structure (and the decorative layer) can be obtained, wherein the top structure (and the decorative layer) moreover can be applied in an accurate manner with a high level of detail, which leads to realistic appearances and unique, one-of-a-kind decorative panels. This result cannot be achieved by means of traditional mechanically impressed covering structures. As printing device(s), for example, one or more inkjet printers and/or laser printers may be used. As indicated above, a substantially transparent or translucent part of the top structure may be partially or entirely digitally printed. The decorative visual print layer is preferably digitally printed. To this end, transparent or translucent, either coloured or non-coloured (transparent), ink may be used.

This allows the printed decorative image to remain visible. The printed decor image(s) of the decorative layer(s) may be based on the CMYK colour principle where the white colour is typically provided by the surface of the white base coat (if applied). This is a 4-color setup comprising cyan, magenta, yellow and black. Mixing these together will give a colour space/gamut, which is relatively small. To increase specific colour or the total gamut spot colours may be added. A spot colour may be any colour. One or more additional colours may be applied, such as at least one additional colour selected from the group consisting of: orange, green, blue, red, white, light grey, light magenta, and light cyan. These colours may be used separately or in combinations. The colours are typically mixed and controlled by a combination of software and hardware (print engine/print heads).

Preferably, at least a part of the textured surface of the top structure is aligned in register with at least a part of at least one decor image formed by the decorative print layer, in particular at least one pattern defined by at least one decor image formed by the decorative print layer. By applying an alignment in register, also referred to as embossing in register, a very realistic and/or artistic design and appearance of the panel can be realized. In this manner, for example, a realistic wood nerve pattern can be realized, wherein the decorated printed wood nerves (2D) are in register (in line) with the embossed printed wood nerves (3D). The same effect can, for example, be realized with a stone like design, an animal skin design, etcetera. Also, in case one or more artificial, decorative grout lines are printed, the textured surface may comprise one or more recessed channels directly above said decorative grout lines to realize a realistic appearance of the panel which is practically equal to the surface relief obtained when using real tiles and grouts.

The visual decorative print layer may be composed solely of a decorative ink layer, but is also imaginable that the visual print layer comprises a substrate layer, such as a polymer film or paper film, onto which a decorative ink layer is printed or otherwise applied. Said visual print layer may be attached directly to the core, e.g. by fusing the visual print layer onto the core or by gluing the visual print layer to the core, wherein use can be made e.g. of a polyurethane adhesive. Optionally, an upper surface of the core is covered by at least one primer layer before attaching the visual print layer to the core, wherein the visual print layer will actually be attached to the (upper) primer layer applied to the core. As mentioned above, the decorative top structure can be partially or entirely by realized by digital printing. Optionally, the substance, in particular the ink, to realize at least a part of the wear layer and/or top coating can be free of photoinitiators. It is imaginable that the decorative top structure comprises a decorative visual print layer and a single-only one-transparent or translucent wear layer on top of said visual print layer without applying a separate top coating layer. At one wear layer, and preferably each wear layer in case a plurality of wear would be applied, is preferably made of transparent or translucent polyurethane or, alternatively, polyvinylchloride, polypropylene, or any another suitable transparent or translucent polymer. Typically, at least one layer of the decorative top structure is cured by using UV curing, and at least one, preferably other, layer of the decorative top structure is cured by using EB curing.

Preferably, the embossing structure and/or preferably textured (or structured) multi-layered covering structure is at least partially EB cured. One or more layers and/or one or more surface areas (sections) of the covering structure may be EB cured. It is imaginable, and it may even be preferable, that at least one part of the embossing structure and/or multi-layered covering structure is EB cured and at least one other part of said embossing structure and/or multi-layered covering structure is UV cured. These EB cured part(s) and UV cured part(s) are preferably situated side-by-side, but may alternatively or additionally also be situated on top of each other (e.g. one or more EB cured parts on top of one or more UV cured parts and/or vice versa). This latter may lead to matt and more shiny parts of the embossing structure and/or multi-layered covering structure. This could lead to a more attractive and/or more realistic aesthetical appearance.

Preferably, the embossing structure (i.e. the embossed center portion of the covering structure) of the decorative top structure comprises: at least one, at least partially cured base layer provided with a plurality of indentations, and/or at least one at least partially cured elevated pattern layer formed by a plurality of elevations printed on top of said base layer. Preferably, at least the base layer and/or the elevated pattern layer of the embossing structure is an Electron Beam (EB) cured layer. The combination of the negative embossing layer (at least partially formed by the indentations/recesses) and the positive embossing layer (at least partially formed by the elevations) results in a more pronounced (rough and hilly) embossing structure, wherein relatively deep embossings may be created, which leads to a more realistic appearance of the surface covering element as such. Due to the relatively deep embossings which may be created by applying the multi-level layered embossing structure, a more realistic light effect as well as a better depth effect can be obtained, wherein the colours of the decor image are typically better perceptible. Typically, an upper side of the base layer defines an embossing base level, and wherein the indentations and at least a part and/or at least a number of the elevations are situated at opposite sides of said embossing base level. It is also imaginable that the indentations and at least a part and/or at least a number of the elevations are situated at the same side of said base level.

Typically, a part of the base layer is provided with said plurality of indentations, and wherein another part of the base layer is free of indentations. Hence, in this embodiment, the base layer is merely partially embossed. The elevations, of at least a part thereof and/or a number thereof, are preferably printed on the part of the base layer which is free of indentations, which leads to an increased depth effect of the embossing structure as such.

It is imaginable that the plurality of indentations of the base layer forms a discontinuous and/or a continuous indentation pattern. It is also imaginable that the plurality of indentations of the base layers forms a regular indentation pattern. Typically, the indentation pattern to be realized is strongly, or even completely, dependent on at least one decor image of the decorative layer.

Preferably, the base layer is a printed base layer, more preferably a digitally printed base layer. This means that the base layer, initially in liquid state, is printed either directly or indirectly on top of the decorative layer. One or more indentations may be provided in the base layer when the base layer is still in liquid state and/or one or more indentations may be provided in the base layer during and/or after curing (solidifying) the base layer. Providing one or more indentations in the liquid base layer is preferably done by means of chemically embossing. To this end, preferably (small) droplets of an embossing liquid are position-selectively printed (sprayed) onto the liquid base layer to cause a chemical reaction between the material of the printed droplets and the still liquid base layer, wherein the subsequent reaction product changes the structure at this location of the base layer optically and/or haptically. Providing one or more indentations in the base layer during or after curing may be done by either chemical embossing (as described above) and/or by mechanical embossing e.g. by using a laser or particle beam, such as a water beam.

Preferably, the indentations provided in the base layer have a depth situated in between 2 micron and 100 micron, preferably situated in between 3 micron and 50 micron. Preferably, the elevations of the elevated pattern layer have a height situated in between 2 micron and 500 micron, preferably situated in between 3 micron and 300 micron. The total embossing depth is determined by the sum of the greatest indentation depth and the greatest elevation height. In case a plurality of base layers and/or a plurality of elevated pattern layers is applied, an increase of the total embossing depth can be achieved.

Apart from the use of EB for curing purposes, the EB may also (additionally) be used to create a texture in an upper surface of at least one layer of the covering structure. The accelerated electrons of the electron beam may be used to realize an electron bombardment of the layer to be cured, that material of said layer is pushed away, deformed, and removed (etched away) resulting in an EB caused texture. Since the resolution of this electron bombardment can be relatively high, nanotextures can be realized e.g. to refine a more coarse, preferably printed, embossing structure already realized earlier in the production process of the panel according to the invention. This will improve the look and feel of the embossing structure, and hence the look and feel of the panel as such.

It is imaginable that at least a part of an upper surface of the embossing structure is provided with an actively roughened texture, which is typically realized by means of brushing and/or blasting.

Preferably, the decorative panel further comprises at least one primer layer, preferably situated between the core and the decorative top structure. The primer is preferably white. Preferably, the primer layer has a surface density situated between 18 g/m2 and 26 g/m2, preferably between 20 g/m2 and 24 g/m2. At least one wear layer preferably has a surface density situated between 55 g/m2 and 105 g/m2, preferably between 64 g/m2 and 96 g/m2.

As mentioned above, a plurality of layers are mutually chemically bonded, preferably by means of EB curing. Preferably, the top coating is chemically bonded to at least one wear layer and/or wherein the wear layer is chemically bonded to the decorative print layer and/or wherein the wear layer is chemically bonded to the core layer and/or wherein the decorative print layer is chemically bonded to a layer underneath said decorative print layer.

Preferably, the at least one Electron Beam (EB) cured layer comprises a thermoplastic polymer chosen from the group consisting of: PVC, PU, and acrylic resin, such as PMMA.

In a preferred embodiment, the top structure is partially Electron Beam cured, wherein the Electron Beam curing depth is situated in between 0.2 and 0.8 mm, preferably in between 0.3 and 0.5 mm.

Preferably, a first panel edge comprises a first coupling profile, and a second panel edge, preferably opposite to the first panel edge, comprises a second coupling profile being designed to engage interlockingly with said first coupling profile of an adjacent surface covering element, both in horizontal direction and in vertical direction, wherein the first coupling profile and the second coupling profile are preferably configured such that two of such panels can be coupled to each other by means of a lowering movement (fold-down movement). Preferably, the first coupling profile comprises:
an upward tongue,
at least one upward flank lying at a distance from the upward tongue,
an upward groove formed in between the upward tongue and the upward flank wherein the upward groove is adapted to receive at least a part of a downward tongue of a second coupling profile of an adjacent panel, and
optionally, at least one first locking element, preferably provided at a distant side of the upward tongue facing away from the upward flank, and wherein the second coupling profile preferably comprises:
a first downward tongue,
at least one first downward flank lying at a distance from the downward tongue,
a first downward groove formed in between the downward tongue and the downward flank, wherein the downward groove is adapted to receive at least a part of an upward tongue of a first coupling profile of an adjacent panel, and
optionally, at least one second locking element adapted for co-action with a first locking element of an adjacent panel, said second locking element preferably being provided at the downward flank.

Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces.

Preferably, the panel comprises at least one third coupling profile and at least one fourth coupling profile located respectively at a third edge and a fourth edge, wherein the third coupling profile comprises:
a sideward tongue extending in a direction substantially parallel to the upper side of the core,
at least one second downward flank lying at a distance from the sideward tongue, and
a second downward groove formed between the sideward tongue and the second downward flank,
wherein the fourth coupling profile comprises:
a third groove configured for accommodating at least a part of the sideward tongue of the third coupling profile of an adjacent surface covering element, said third groove being defined by an upper lip and a lower lip, wherein said lower lip is provided with an upward locking element,
wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

The invention also relates to a covering, in particular a floor covering consisting of a plurality of, preferably interconnected, panels according to the invention.

The invention moreover relates to a method for producing a decorative panel, preferably a decorative panel according to the invention, comprising the steps of:

providing least one core having an upper side and a lower side
applying a decorative top structure, directly or indirectly, on the upper side of the core, comprising the steps of:
B-i) applying at least one decorative print layer;
B-ii) applying at least one substantially transparent or translucent wear layer, at least partially covering the at least one print layer;
B-iii) applying at least one top coating;
curing at least one of the layers applied during step B-ii) and/or B-iii) by means of Electron Beam (EB) curing.

Preferably, the top coating applied during step B-iii) is cured using Electron Beam (EB) curing. Preferably, at least one of the layers applied during step B-i), and/or B-ii), and/or A) is cured by means of UV-curing.

Preferably, the method further comprising the step of step D), applying at least one primer, preferably a UV curable primer, wherein step D) is performed prior to step B).

Preferably, the top coating is applied during step B-iii) with a surface density situated between 6 g/m2 and 18 g/m2, preferably between 8 g/m2 and 16 g/m2, more preferably between 10 g/m2 and 14 g/m2.

In a preferred embodiment, at least one, preferably each, of the steps A), and/or B-i), and/or B-ii) is executed at a temperature situated between 10 degrees Celsius and 30 degrees Celsius, preferably between 15 degrees Celsius and 25 degrees Celsius.

Preferably, during step C) electrons are accelerated at 70-300 kV. During step C) preferably, at least one shaped electron beam is directed towards the at least one panel layer to be cured. It is imaginable that the panel layer to be cured is exposed simultaneously and/or successively to a plurality of electron beams. It is imaginable that the panel is exposed simultaneously and/or successively to at least one electron beam and at least one UV lamp.

The invention additionally relates to a system for producing a decorative panel, in particular a floor panel, ceiling panel or wall panel, preferably a decorative panel according to the invention and/or preferably by using the method according to the invention, comprising:
a core feed station, for providing a core;
an optional primer station, situated downstream of the core feed station, for applying a primer layer onto core;
a decorative printing station, located downstream of the primer station, for, preferably digitally, printing at least one decorative image onto the primer layer and/or onto the core;
at least one first coating station, situated downstream of the decorative printing station, for applying, optionally by using digital printing, at least one, preferably at least partially UV-curable, wear layer onto the decorative print layer, said coating at least partially covering the decorative image;
at least one second coating station, provided downstream of the at least one first coating station, for applying, optionally by using digital printing, at least one top coating onto the first cured layer;
at least one optional first curing station, preferably a UV-curing station, situated downstream of the at least one first coating station, for at least partially curing the wear layer and/or the top coating; and
at least one second curing station, situated downstream of the at least one second coating station, wherein said at least one second curing station is a Electron Beam curing station configured to at least partially cure the top coating and optionally the at least one wear layer.

The system preferably comprises at least one control unit programmed to execute the method according to the invention.

### BRIEF DESCRIPTION OF THE DRAWINGS

The invention will be elucidated on the basis of non-limitative exemplary embodiments shown in the following figures, wherein:

FIG. 1a shows a part of the manufacturing process according to the invention;

FIGS. 2a and 2b show a schematic representation of a panel according to the invention;

FIG. 3 shows another example of a decorative panel according to the invention;

FIGS. 4a and 4b show non-limiting examples of coupling profiles according to the present invention; and

FIG. 5 shows a schematic overview of a production line for manufacturing a panel according to the invention.

### DETAILED DESCRIPTION

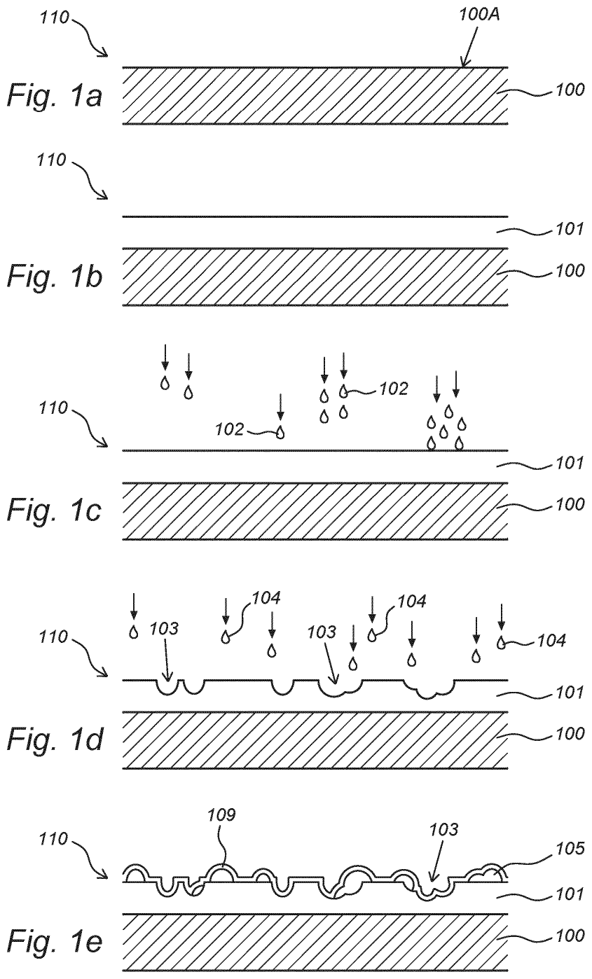

FIG. 1a show an example of subsequent steps of a method according to the present invention. FIG. 1a shows a schematic representation of a cross section of a decorative panel (110). The figure shows the core (100) of the panel (110). The core (100) is typically substantially rigid, and may possibly comprises at least one polymer and/or at least one wood-based material. A decor image is formed onto the upper side (1 00A) of the core (100) by means of printing, in particular digital printing. Optionally, a primer may be applied prior to applying a decor image onto the upper side (1 00A) of the core (100). Said primer may for example be applied in an amount situated between 15 g/m2 and 30 g/m2, preferably between 20 g/m2 and 24 g/m2. It is conceivable that said primer is a UV-curable primer, which may be cured by means of a mercury light source,
wherein the light energy is adjusted to any value in the range of 190 to 280 mJ. FIG. 1b show that a liquid base layer (101) is applied on the decor image formed at the upper side (1 00A) of the panel

(110). The liquid forming the liquid base layer (101) is for example a UV material. The liquid base layer (101) generally has a relatively high surface tension in order to allow precise embossing in the liquid base layer (101). The base layer (101) is preferably at least partially cured prior to applying the embossing. FIG. 1c shows that a plurality of embossing droplets (102) is position-selectively printed on the still liquid, or partially liquid base layer (101). This is done such that the thickness of the base layer (101) changes on the positions where the embossing droplets (102) are spayed on. Alternatively or additionally, the embossing droplets (102) may inhibit the curing of the base layer (101) locally, such that after curing the base layer (101), the embossing droplets (102) remain liquid and may be removed by means of e.g., a brush. FIG. 1 d shows that this results in that positions indentations (103) are formed in the liquid base layer (101) at the positions where the embossing droplets (102) are sprayed on, or removed by means of a brush as discussed above. Subsequently an elevated pattern layer is formed by position-selectively printing of a plurality elevations on the base layer (101). The elevation droplets (104) applied onto the panel (110) are shown in FIG. 1 d. The pattern layer obtained via the position-selectively printing of the elevations (105) is subsequently at least partially cured. FIG. 1 e shows the application of a finishing layer or top coating (109) is applied on top of the base layer (101) and the elevations (105). Preferably, the top coating (109) is applied in a dosage situated between 8 g/m2 and 16 g/m2, preferably 10 g/m2 and 14 g/m2. The top coating (109) is preferably an Electron Beam curable coating, cured via Electron Beam radiation at an energy adjusted to any value in the range of 25 kGy to 45 kGy, preferably 30 kGy to 40 kGy. The finishing layer (109) is in particular cured by means of Electron Beam curing. This may provide a matt look of the surface of the panel. Alternatively or additionally, also a part of the base layer (101) and/or a part of the elevations (105) may be partially cured by means of Electron Beam curing. By using this curing technique, layers may be mutually chemically bonded together, establishing a better attachment therebetween. In particular chemical bonding between the finishing layer, or top coating (109). In general the base layer (101) may also be referred to as the wear layer (101) of the panel which preferably is substantially transparent or translucent. It is preferred that this wear layer (101) is applied in an amount situated between 60 g/m2 and 100 g/m2. The wear layer may in particular be UV-curable, by means of a mercury light source having an energy adjusted to any value in the range of 240-280 mJ. Via the steps shown in FIG. 1a, a decorative panel (110) is obtained, comprising a core (100) and a decorative top structure affixed on the upper side (1 00A) of the core (100). The decorative top structure comprises a decorative print layer forming at least one decor image and a substantially transparent or translucent multi-layered covering structure at least partially covering said print layer. At least one layer of the printed multi-layered covering structure, in particular the wear layer (101), is formed by a substantially transparent or translucent three-dimensional embossing structure, said embossing structure optionally is a multi-layer embossing structure which comprises a base layer (101) provided with a plurality of indentations (103) and an elevated pattern layer formed by a plurality of elevations (105) printed on top of said base layer (101). It can be seen that the indentations (103) and the elevations (105) can overlap, such that a panel (110) having an irregular height structure is obtained. The plurality of indentations (103) of the base layer (101) forms a discontinuous indentation pattern. The panel (110) may possibly comprise multiple coupling profiles for coupling multiple panels (110). The panel (110) may also comprise a backing layer (not shown) affixed to a lower side of the core (100).

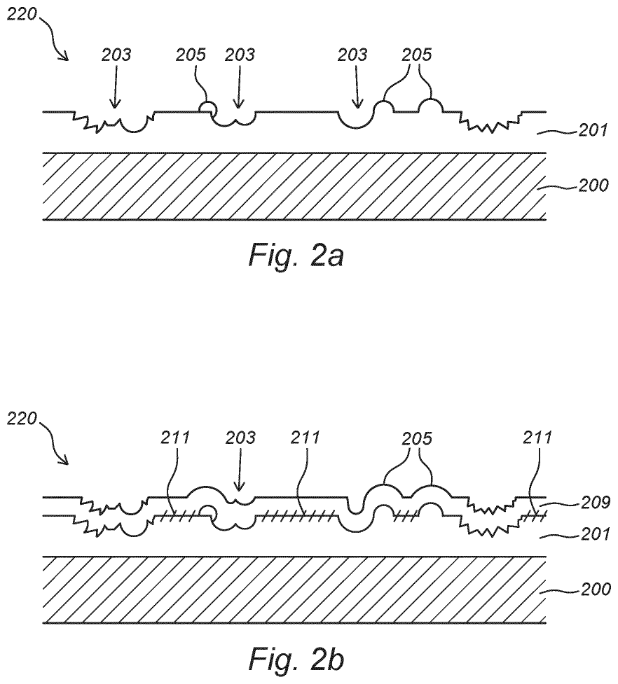

FIGS. 2a and 2b show a schematic representation of a panel (220) according to the invention. FIG. 2a shows the panel (220) prior to application of the top coating (209). The panel (220) comprises a core (200) having an upper and lower side, wherein a decorative top structure is provided onto the core (200). On the upper side of the core (200) a primer may be applied prior to applying a decor image thereon. Said primer may for example be applied in an amount situated between 15 g/m2 and 30 g/m2, preferably between 20 g/m2 and 24 g/m2. It is conceivable that said primer is a UV-curable primer, which may be cured by means of a mercury light source, wherein the light energy is adjusted to any value in the range of 190 to 280 mJ. On top of the decor image (not shown) a substantially transparent or translucent covering structure may be provided. Of said covering structure only the at least one wear layer (201) is shown in FIG. 2a. It is preferred that this wear layer (201) is applied in an amount situated between 60 g/m2 and 100 g/m2. The wear layer may in particular be UV-curable, by means of a mercury light source having an energy adjusted to any value in the range of 240-280 mJ. Said wear layer (201) may be provided with a plurality of indentations (203) and elevations (205) such that said an embossing structure is formed. At least a part of the indentations (203) may be applied by means of an embossing liquid. Said embossing liquid may for example be a UV inhibitor, which prevents curing of (a part of) the wear layer (201) under UV curing station. The uncured portion may be removed by means of a brushing action. However, indentations may also be formed by means of Electron Beam embossing. By directing at least one Electron Beam to the uncured, or partially cured, or fully cured wear layer (201) material may be locally removed via the high energy of the Electron Beam. Since this technique does not require a liquid, a bigger design flexibility may be achieved. That is, the indentations (203) may be formed with sharper corners compared to embossing liquid, yielding a more natural look. FIG. 2b shows the panel (220) after application of the top coating (209). Preferably, the top coating (209) is applied in a dosage situated between 8 g/m2 and 16 g/m2, preferably 10 g/m2 and 14 g/m2. The top coating (209) is preferably an Electron Beam curable coating, cured via Electron Beam radiation at an energy adjusted to any value in the range of 25 kGy to 45 kGy, preferably 30 kGy to 40 kGy. The top coating (209) and wear layer (201) together defined the substantially transparent or translucent multi-layered covering structure according to the invention. In this respect, at least one of the layers of the covering structure may be formed by a substantially transparent or translucent three-dimensional embossing structure, in particular the wear layer (201) thereof. The figure further shows that a chemical bonding (211) is established between parts of the top coating (209) and the wear layer (201), this may be achieved since the top coating (209) is at least partially cured via Electron Beam curing. It is also conceivable that Electron Beam curing may be applied to, at least partially, curing the wear layer (201), such that a chemical bond may be formed between the wear layer (201) and the decor image and/or the primer and/or the core (200). Therefore, Electron Beam curing contributes to the overall integrity of the panel (220).

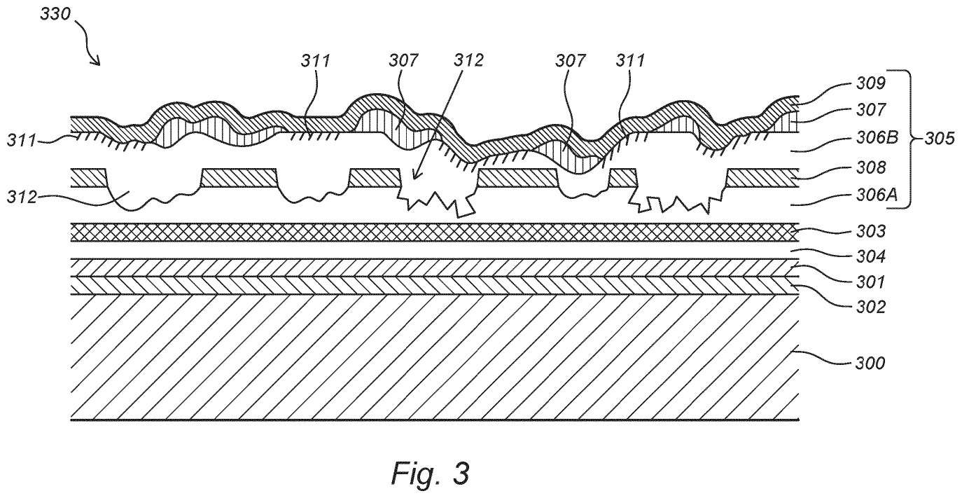

FIG. 3 shows a schematic representation of a further example of a decorative panel (330) according to the present invention. The figure show a cross section of a decorative panel (330), in particular a floor panel (330). The panel (330) comprises a core (300) provided with an upper side and a lower side. A decorative print layer (301) is indirectly affixed on the upper side of the core (300). A carrier layer (302) formed by a primer (302) is present in between the core (300) and the decorative layer (301) in order to provide better adhesion of the decorative layer (301). Said primer (302) may for example be applied in an amount situated between 15 g/m2 and 30 g/m2, preferably between 20 g/m2 and 24 g/m2. It is conceivable that said primer (302) is a UV-curable primer, which may be cured by means of a mercury light source, wherein the light energy is adjusted to any value in the range of 190 to 280 mJ. Optionally an intermediate layer (303) may be present on top of the printed decorative top layer (301). The intermediate layer (303) may be formed by a transparent or translucent thermoplastic layer (303). The thermoplastic layer (303) is in this non-I imitative embodiment provided onto the printed decorative layer (301) by means of a hot melt glue layer (304). However, it is also conceivable that said thermoplastic layer (303) is provided by other means, such as chemical bonding via Electron Beam curing. A substantially transparent or translucent multi-layered covering structure (305) is positioned directly or indirectly on top op of aforementioned layers (300, 301, 302, 303, 304). The covering structure (305) may in particular be a multi-layered covering structure (305) comprising at least one wear layer (306A, 306B) and at least one top coating (309), provided directly or indirectly on top of said at least one wear layer (306A, 306B). It is preferred that at least one wear layer (306A, 306B) is applied in an amount situated between 60 g/m2 and 100 g/m2. The wear layer (306A, 306B) may in particular be UV-curable, by means of a mercury light source having an energy adjusted to any value in the range of 240-280 mJ. Preferably, the top coating (309) is applied in a dosage situated between 8 g/m2 and 16 g/m2, preferably 10 g/m2 and 14 g/m2. The top coating (309) is preferably an Electron Beam curable coating, cured via Electron Beam radiation at an energy adjusted to any value in the range of 25 kGy to 45 kGy, preferably 30 kGy to 40 kGy. The wear layer and top coating are in this particular embodiment formed by a substantially transparent or translucent three-dimensional embossing structure (305). The embossing structure (305) is a multi-layer embossing structure (305) which comprises two at least partially cured base layers (306A, 306B) provided with a plurality of indentations (312). A part of each base layer (306A, 306B) is free of indentations. The embossing structure (305) also comprises an elevated pattern layer (307) formed by a plurality of elevations printed on top of the upper base layer (306B). The elevations are both printed on parts of the base layer (306B) that respectively provided with indentations and parts that are free of indentations. Despite not shown, it is also conceivable that an embossing layer is present on top of the lower base layer (306A). A secondary printed decorated layer (308) is affixed to the lower base layer (306A). This printed decorative layer (308) is affixed to the parts of the base layer (306A) which is free of indentations. The entire panel (330) is covered with a top coating (309), in particular an Electron Beam cured top coating (309). The panel (330) benefits of the presence of two printed decorative layers (301, 308), resulting in that a unique visual pattern can be obtained. The indentations provided in the base layer (306A, 306B) may be provided via different techniques. In this non I imitative embodiment, a part of the indentations (312) are provided via embossing droplets, as described with respect to FIG. 1a. Two indentations shown in FIG. 3 are however provided by means of Electron Beam application. This technique for providing negative embossing has turned out to provide more realistic indentations (312). In particular the sharp corners as present in natural wood nerves may be more realistically applied. This is due to the relatively high energy of Electron Beams, which may be used to locally disrupt the surface hence generating the indentation. By tuning the energy of the Electron Beam, different indentation depths may be achieved. Moreover, the indentations provided via Electron Beam may be established at the same time the base layer (306A, 306B) is cured. This may decrease the amount of production steps required. The figure also indicates that the top coating (309) locally established a chemical bond (311) with the adjacent layer.

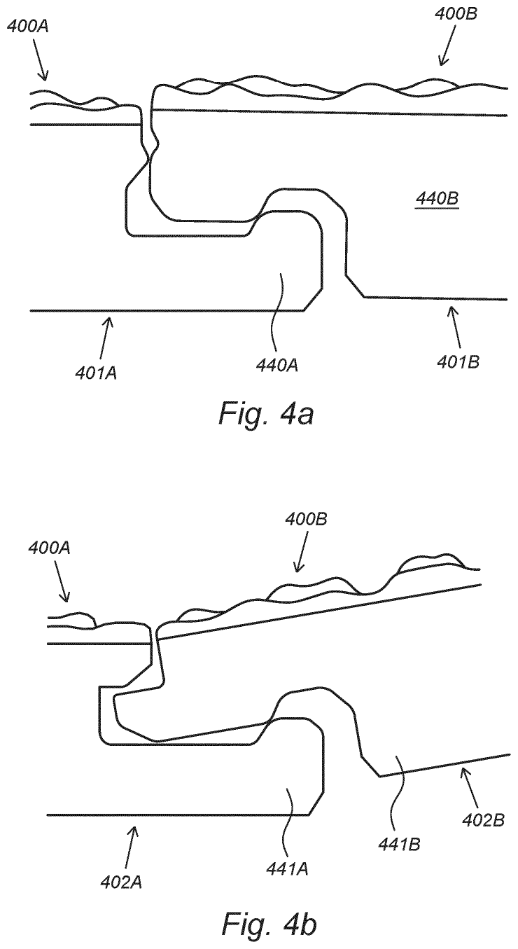

FIGS. 4a and 4b show non-limiting examples of coupling profiles (401 A, 401 B, 402A, 402B) used in panels (400A, 400B) according to the present invention. A first panel edge (440A) comprises a first coupling profile (401 A), and a second panel edge (440B) opposite to the first panel edge (440A), comprising a second coupling profile (401 B) being designed to engage interlockingly with said first coupling profile (401A) of an adjacent panel, both in horizontal direction and in vertical direction, wherein the first coupling profile (401 A) and the second coupling profile (401 B) are configured such that two of such panels can be coupled to each other by means of a lowering movement. This is shown in FIG. 4a. FIG. 4b show the panel comprising a third coupling profile (402A) and a coupling profile (402B) located respectively at a third panel edge (441 A) and a fourth panel edge (441 B). The third coupling profile (402A) and the fourth coupling profile (402B) are configured such that two of such panels (440A, 440B) can be coupled to each other by means of a turning movement, wherein, in coupled condition: at least a part of the sideward tongue of a first panel is inserted into the third groove of an adjacent, second panel, and wherein at least a part of an upward locking element of said second panel is inserted into the second downward groove of said first panel.

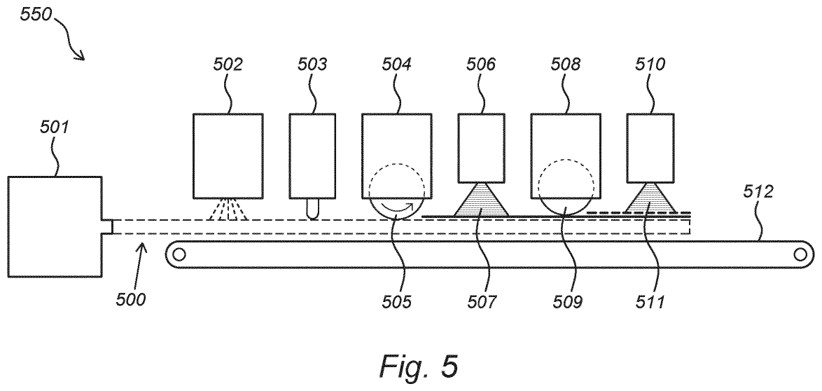

FIG. 5 depicts a simplified overview of a system for manufacturing a panel according to the invention. The system (550) thereto shows a core feed station

(501), which may be for example a core extrusion device (501) for extruding a slab of core material (500). The slab of core material (500) is transported, for example by the conveyor (512), to a first station. In this case the first station (502) is formed by a primer station (502) for applying a primer layer onto the slab of core material (500). Said primer may for example be applied in an amount situated between 15 g/m2 and 30 g/m2, preferably between 20 g/m2 and 24 g/m2. It is conceivable that said primer is a UV-curable primer, which may be cured by means of a mercury light source, wherein the light energy is adjusted to any value in the range of 190 to 280 mJ. It is also conceivable that, in case of multiple primer stations (502) are provided, that the total amount of primer applied by subsequent primer stations (502) adds up to the mentioned amount per square meter. The primer layer may provide for a better attachment of the decorative print layer. The decorative print layer is applied by a decorative printing station (503), which may apply, preferably digitally, a decor image onto the primer layer that is applied. Downstream of the printing station (503) a first coating station (504) is arranged. The first coating station (504) applies, in this case via at least one application roller (505) a first UV curable wear layer onto the slab. It is preferred that this wear layer is applied in an amount situated between 60 g/m2 and 100 g/m2. When multiple first coating stations (504) are arranged, the total amount of primer added by each of the stations (504) preferably adds up to the aforementioned amount per square meter. The first UV curable wear layer is cured via the first UV curing station (506), located downstream of the first coating station (504). Preferably said first curing station (506) cures the coating by means of a mercury light source having an energy adjusted to any value in the range of 240-280 mJ. Downstream thereof, a second coating station (508), for applying a top coating, and a second curing station (510) may be arranged. The second coating station (508) may apply, for example via a roller (509) a curable coating, preferably a coating curable via Electron Beam curing. Preferably, the top coating (109) is applied in a dosage situated between 8 g/m2 and 16 g/m2, preferably 10 g/m2 and 14 g/m2. When multiple second coating stations (508) are arranged, the total amount of top coating added by each of the stations (508) preferably adds up to the aforementioned amount per square meter. The second curing station (510) is configured for curing the second coating, via Electron Beam radiation at an energy adjusted to any value in the range of 25 kGy to 45 kGy, preferably 30 kGy to 40 kGy. Via Electron Beam curing the top coating may be chemically bonded to the at least one wear layer applied. It is conceivable that between the first curing station (506) and the second coating station (508) a plurality of further coating and/or curing stations are arranged, for applying additional wear layers. It is also conceivable that between the first coating station (504) and the first curing station (506) an embossing station is arranged, for applying an embossing structure to the panel. The embossing structure may for example be applied as described within this application. This may for example be realized by means of an embossing liquid station, for applying position selectively an embossing liquid onto the slab of core material (500), which may to this end be partially cured.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re) combined in order to arrive at a specific application.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1: Decorative panel, in particular a floor panel, ceiling panel or wall panel, comprising:
a core provided with an upper side and a lower side,
a decorative top structure affixed, directly or indirectly, on said upper side of the core, said decorative top structure comprising:
at least one decorative print layer forming at least one decor image,
at least one substantially transparent or translucent multi-layered covering structure at least partially covering said print layer, the covering structure comprising at least one wear layer and a top coating, directly or indirectly, on top of said at least one wear layer,
wherein at least one layer of the multi-layered covering structure is an Electron Beam (EB) cured layer.

2: Decorative panel according to claim 1, wherein the top coating is an Electron Beam (EB) cured top coating.

3: Decorative panel according to claim 1, wherein the top coating has surface density situated between 6 g/m2 and 18 g/m2, preferably between 8 g/m2 and 16 g/m2, more preferably between 10 g/m2 and 14 g/m2.

4: Decorative panel according to claim 1, wherein the top coating is chemically bonded to at least one adjacent layer of the covering structure, the at least one adjacent wear layer.

5: Decorative panel according to claim 1, wherein the top coating is essentially impermeable for substances, such as an odorous and/or plasticizing substance, optionally present in and/or optionally making part of other layers of the decorative panel.

6: Decorative panel according to claim 1, wherein the at least one layer of the multi-layered covering structure, preferably the top coating, is cured at an irradiation dose situated between 20 kGy and 50 kGy, preferably between 30 kGy and 40 kGy.

7: Decorative panel according to claim 1, wherein the top coating is provided, directly or indirectly, on an upper surface of the wear layer.

8: Decorative panel according to claim 1, wherein the top coating is a substantially uniform top coating.

9: Decorative panel according to claim 1, wherein at least one layer of the printed multi-layered covering structure, in particular the wear layer, is formed by a substantially transparent or translucent three-dimensional embossing structure at least partially covering said decorative print layer.

10: Decorative panel according to claim 9, wherein the embossing structure comprises at least one, at least partially cured base layer provided with a plurality of indentations.

11: Decorative panel according to claim 9, wherein the embossing structure further comprises at least one at least partially cured elevated pattern layer formed by a plurality of elevations printed on top of said base layer.

12: Decorative panel according claim 9, wherein at least a part of the embossing structure is Electron Beam (EB) cured, wherein, preferably, at least the base layer and/or the elevated pattern layer of the embossing structure is an Electron Beam (EB) cured layer.

13: Decorative panel according claim 9, wherein the embossing structure is an at least partially printed embossing structure, preferably an at least partially digitally printed embossing structure.

14: Decorative panel according to claim 13, wherein a textured upper surface of the embossing structure is at least partially defined by printing, preferably digital printing.

15: Decorative panel according to claim 9, wherein a textured upper surface of the embossing structure comprises etched away portions, wherein said etched away portions are realized by Electron Beam curing.

16: Decorative panel according to claim 9, wherein at least a part of an upper surface of the embossing structure is provided with an actively roughened texture.

17: Decorative panel according to claim 9, wherein at least a part of the embossing structure is EB cured, and wherein at least one other part of the embossing structure is UV cured.

18: Decorative panel according to claim 9, wherein the decorative panel further comprises at least one primer layer, preferably situated between the core and the decorative top structure.

19: Decorative panel according to claim 18, wherein the primer layer has a surface density situated between 18 g/m2 and 26 g/m2, between 20 g/m2 and 24 g/m2.

20-28. (canceled)

29: A method for producing a decorative panel, in particular a floor panel, ceiling panel or wall panel, preferably a decorative panel according to any of the preceding claims, comprising the steps of:
providing least one core having an upper side and a lower side applying a decorative top structure, directly or indirectly, on the upper side of the core, comprising the steps of:
applying at least one decorative print layer;
applying at least one substantially transparent or translucent wear layer, at least partially covering the at least one print layer;
applying at least one top coating; and
curing at least one of the layers applied during step B-ii) and/or B-iii) by means of Electron Beam (EB) curing.

30-38. (canceled)
